(19) United States
(12) Patent Application Publication
(10) Pub. No.: US 2026/0241637 A1
(43) Pub. Date: Aug. 20, 2026

(54) INNOVATIVE PHOTOMOBILE POLYMER, METHOD FOR PREPARING SAID PHOTOMOBILE POLYMER WITHOUT RUBBING, 3D PRINTING METHOD OF SAID PHOTOMOBILE POLYMER AND 3D PRINTER TO IMPLEMENT SAID 3D PRINTING METHOD

(71) Applicants: CONSIGLIO NAZIONALE DELLE RICERCHE, Roma (IT); ENEA - Agenzia nazionale per le nuove tecnologie, l’energia e lo sviluppo economico sostenibile, Roma (IT)

(72) Inventors: Domenico SAGNELLI, Caserta (IT); Ambra VESTRI, Pistoia (IT); Lucia PETTI, Napoli (IT); Fulvia VILLANI, Roma (IT); Tiziana POLICHETTI, Roma (IT); Giuseppe Nenna, Roma (IT)

(21) Appl. No.: 19/162,496

(22) PCT Filed: Mar. 12, 2024
(86) PCT No.: PCT/IB2024/052372

§ 371 Date: Sep. 5, 2025

(30) Foreign Application Priority Data
Mar. 14, 2023 (IT) 102023000004722

(51) Int. Cl. B29C 64/129; B29C 64/205; B29C 64/245; B29C 64/314; B29K 101/00; B33Y 10/00; B33Y 30/00; B33Y 40/10; B33Y 70/00; C09K 19/24; C09K 19/54; C09K 19/58; G02F 1/1337

(52) U.S. Cl. CPC B29C 64/129; B29C 64/205; B29C 64/245; B29C 64/314; B33Y 10/00; B33Y 30/00; B33Y 40/10; B33Y 70/00; C09K 19/24; C09K 19/542; C09K 19/58; G02F 1/133788; B29K 2101/00; B29K 2995/0097; C09K 2019/548; G02F 2202/023; G02F 2202/06

(57) ABSTRACT

A process for the preparation of a doped photomobile polymer characterised by having no rubbing stage, as well as the photomobile polymer obtained by said process and a method of 3D-printing said photomobile polymer or comprising arranging a tank configured to contain a predetermined amount of a non-cross-linked resin of said photomobile polymer are described.

### BACKGROUND ART

The inventors of the present invention have previously synthesised photopolymers doped with ZnO nanoparticles in a concentration of 6%. The process involved rubbing the substrate so that the liquid crystal molecules took on an orientational order (Sagnelli D. et al., Photo-Responsivity Improvement of Photo-Mobile Polymers Actuators Based on a Novel LCs/Azobenzene Copolymer and ZnO Nanoparticles Network, Nanomaterials 2021, 11, 3320. https://doi.org/10.3390/nano11123320). Resins comprising 2-phenyltethylacrylate (2PA), isobornyl acrylate (IBOA) and doped with zinc oxide nanoparticles used in 3D printing are further known in the art (Ng, C. S., Subramanian, A. S. & Su, P. (2022). Zinc oxide nanoparticles as additives for improved dimensional accuracy in vat photopolymerization. Additive Manufacturing, 59 (Part A), 103118-. https://dx.doi.org/10.1016/j.addma.2022.103118). These common UV-activated resins do not contain liquid crystals and do not require alignment beforehand; zinc oxide nanoparticles in this context are used as resin additives in place of photoabsorbents to control overexposure that causes loss of dimensional accuracy, reduce resin polymerisation time and prevent unwanted polymerisation, improve tensile strength, fracture deformation and Young's modulus.

### TECHNICAL PROBLEM

In the preparation of photomobile polymers, the methods known in the state of the art typically require the substrate to undergo a “mechanical rubbing” process in order to provide spatial orientation patterns for the molecules interacting with these patterns. These methods require processing steps that are time-consuming and costly and often lead to undesirable variations in the alignment of the liquid crystal molecules, resulting in inconsistent performance of the liquid crystal photopolymer. A further technical problem that the inventors have noticed is that linked to the use of liquid crystal photopolymer in 3D printing applications in which the needs of preparing and/or creating the rubbing layer make this processing step difficult to use. Moreover, the rubbing process can be complex and requires specialised equipment and trained technicians to perform. It is not always affordable, as the equipment and materials required for the rubbing process can be expensive, which can increase the total cost of production. A further issue is repeatability; maintaining consistent results from the rubbing process can be difficult, as it depends on factors such as the pressure applied, the speed of the machine and the uniformity of the polymer surface. The rubbing process can be a source of defects and defects can reduce the performance of the printed materials.

The inventors have surprisingly verified that the specific doping of a liquid crystal polymer with appropriately selected nanoparticles at a specific predetermined concentration allows for a process of spatial self-organisation in which the liquid crystal molecules are aligned in a specific direction without the need for a substrate pre-treated with the rubbing process.

It is relevant to note that the inventors found that this alignment related to spatial self-organisation occurs when specific nanoparticles are added to the liquid crystal (CL) mixture in certain quantities.

In fact, the liquid crystal molecules are attracted to the added nanoparticles due to their surface energy and line up around them in specific directions, thus making it unnecessary to induce further alignment by rubbing.

It has been verified that nanoparticles can influence the nematic order of liquid crystal molecules, thus leading to the possibility of further refining the optimised function of photomobile polymers.

With this in mind, the inventors were able to select suitable concentration ranges of the nanoparticles used that would allow them to obtain photomobile polymers which exhibit improved performance including, inter alia, shorter photo-response times, increased sensitivity to radiation stimuli, as well as greater mechanical stability.

Further, it has been shown that thanks to this technical solution, the photomobile polymers obtained by the process of the present invention are responsive to infrared wavelengths and unpolarised sunlight.

Therefore, the process proposed in the present invention is faster, less laborious, and allows for more consistent and reproducible materials than those obtainable according to the teachings of the state of the art.

In other words, this technical solution allows for better performance of photomobile polymers, including higher Young's or flexural modulus and shorter radiation response times.

The inventors have thus also identified an innovative formulation of a photomobile polymer that can be produced economically while maintaining the mechanical and thermomobility characteristics of alternative state-of-the-art technical solutions. This resin can easily be used in various manufacturing processes including 3D printing such as FDM, SLS AND SLA to specify a few types.

Further, the inventors have found an innovative process for 3D/4D printing of polymer resins to produce objects that are able to be deformed significantly and reversibly upon interaction with light. This process is an alternative to typical 3D resin printing techniques based on stereolithography (SLA) or digital light processing (DLP). Clearly, the state of the art suggests that the rubbing process is mandatory to achieve liquid crystal alignment (Sagnelli D. et al., Photo-Responsivity Improvement of Photo-Mobile Polymers Actuators Based on a Novel LCs/Azobenzene Copolymer and ZnO Nanoparticles Network, Nanomaterials 2021, 11, 3320. https://doi.org/10.3390/nano11123320) also considering that Ng, C. S., Subramanian, A. S. & Su, P. (2022). Zinc oxide nanoparticles as additives for improved dimensional accuracy in vat photopolymerization. Additive Manufacturing, 59 (Part A), 103118-. https://dx.doi.org/10.1016/j.addma.2022.103118) suggests the role of zinc nanoparticles only in controlling the polymerisation of matrices not comprising liquid crystals.

### OBJECT OF THE INVENTION

At least one of the aforementioned technical problems is thus solved according to a first aspect of the present invention relating to a process for the preparation of a photomobile polymer comprising the following steps:
a) doping by incorporation into a non-cross-linked resin comprising at least one monomer and/or oligomer of liquid crystals with an azobenzene moiety, of ZnO nanoparticles in a concentration comprised between 3 and 9%;
b) deposition of the doped polymer obtained at the end of step a) on a suitable substrate

provided that at step b) the substrate is not subjected to rubbing.

It is therefore a second aspect and further object of the present invention to formulate a photomobile polymer obtained by the previously described process involving the doping of a non-cross-linked resin comprising at least one monomer and/or oligomer of liquid crystals having an azobenzene moiety with ZnO nanoparticles in a concentration comprised between 3 and 9% and its deposition on a suitable substrate in which the substrate is not previously subjected to rubbing.

According to a third aspect and further object, the present invention claims a method of 3D printing a photomobile polymer having at least the previously described characteristics, said method comprising arranging a tank configured to contain a predetermined amount of a non-cross-linked photomobile polymer resin.

Preferably, the tank comprises a handling device configured to move a movable bed inside the tank.

Preferably, the method comprises setting up an initial light source, comprised in the tank, configured to selectively irradiate a first predetermined cross-linking layer of the photomobile polymer at the movable bed, producing localised alignment thereof.

Preferably, the method comprises the provision of a second light source, comprised in the tank, configured to selectively irradiate a second predetermined cross-linking layer of the photomobile polymer at the movable bed producing cross-linking thereof.

Preferably, the method comprises placing non-cross-linked resin in the tank.

Preferably, the method comprises positioning the movable bed at the non-cross-linked resin to be polymerised.

Preferably, the method comprises heating the tank to a temperature that is hostile to non-cross-linked resin.

Preferably, the method comprises irradiating with the first light source the first cross-linking layer in such a way as to achieve a selective and localised alignment of said non-cross-linked resin, and/or irradiating with the second light source the second cross-linking layer in such a way as to sculpt the non-cross-linked resin by polymerising and aligning it.

Preferably, the method comprises completing the printing of the photomobile polymer by moving the movable bed by means of the handling device in order to irradiate with the first and/or second light source a new cross-linking layer distinct from the first or second cross-linking layer and repeating the steps described above as required.

According to a fourth aspect and further object, the present invention claims a 3D printer for printing a photomobile polymer having at least the previously described characteristics and adopting the printing method having at least the previously described characteristics.

Preferably, the 3D printer comprises a tank configured to contain a predetermined amount of a non-cross-linked photomobile polymer resin. Preferably, the tank comprises a handling device configured to move a movable bed inside the tank.

Preferably, the 3D printer comprises a first light source configured to selectively irradiate a first predetermined cross-linking layer of the photomobile polymer at the movable bed, producing localised alignment thereof.

Preferably, the 3D printer comprises a second light source configured to selectively irradiate a second predetermined cross-linking layer of the photomobile polymer at the movable bed, producing cross-linking thereof.

The present invention, in at least one of the aforementioned aspects, may have at least one of the further preferred features listed below.

Preferably, the photomobile polymer consists of a non-cross-linked resin comprising at least one liquid crystal monomer and/or oligomer having an azobenzene moiety in a concentration between 6 and 10 mol %, doped with ZnO nanoparticles, in a concentration greater than or different from 6% and less than or equal to 7.5% by weight, with the value of 6% not being included.

This ensures that the photomobile polymer obtained enjoys high reversibility in the specific thermomobility obtained.

Preferably, the first light source is a collimated lamp or strip of LEDs or a polarised source, preferably a polarised laser or an unpolarised laser associated with a polarising foil and a plurality of mirrors or photonic crystals configured to selectively and rapidly reflect said laser light at said first cross-linking layer.

In this way, an initial alignment of the non-cross-linked resin can be achieved selectively and effectively.

Preferably, the LED strip is configured to irradiate said non-cross-linked resin in a pulsed manner.

This makes it possible to optimise the use of the LED strip by reducing electric power consumption and ensuring an ideal pattern in the resin to be cross-linked.

Preferably, the polarised source is polarised perpendicular to the movable bed and has a wavelength comprised between 330-457 nm, preferably between 350-365 nm. In this way, it is possible to selectively produce the alignment of azobenzenes and said non-cross-linked resin.

The Applicant has in fact found that polarised light is capable of isomerising azobenzene if and only if the polarisation of the light is not perpendicular to the azobenzene itself. If this condition is met, the azobenzene begins to isomerise until it spontaneously becomes perpendicular to the polarisation.

This creates a necessary and prodromal condition for the self-alignment of the entire desired photopolymer.

At this point, the azobenzene molecules are all self-aligned and the ideal “guided” polymerisation of the remaining portions can begin.

Preferably, the first light source has a power density comprised between 0.8 and 2.8 W/cm².

This makes it possible to modulate the cross-linking controlled by the density and directionality of the light beam.

Preferably, the first and/or second cross-linking layer has a thickness comprised between 10 microns and 50 microns.

In this way, it is possible to develop a sequence of effectively polymerised multi-layers that can guarantee the desired physical-mechanical properties even in a macroscopically large bulk structure.

Preferably, the movable bed is coated with an alignment layer to facilitate anchorage of liquid crystals comprised in the non-cross-linked resin.

In this way, it is possible to further increase the different designs of patterns according to which the molecules of the resin to be cross-linked can be aligned, increasing the adaptability and performance of the photomobile polymer that can be produced.

The characteristics and advantages of the invention will become clearer from the detailed description of a preferred embodiment thereof, shown by way of non-limiting example.

### DETAILED DESCRIPTION OF THE INVENTION

Within the meaning of the present invention, “doping” means the addition to the polymer of small percentages of foreign molecules that are not part of the polymer itself in order to modify its chemical-physical and functional characteristics.

Within the meaning of the present invention, “rubbing”, e.g. mechanical rubbing, refers to the process of ordering liquid crystal molecules in a specific direction and aligning them.

Again, the term “self-alignment” refers to an alignment process performed “spontaneously” by the resin according to the invention that the Applicant has discovered as a function of a specific chemical composition.

More specifically, the state of the art adopts resins comprising non-cross-linked liquid crystals that require a long-range alignment step in a physical direction in order to perform the desired selective actuation characteristics.

The Applicant has noted that the known technique adopts the use of the aforementioned “rubbing” to produce this desired alignment of misaligned liquid crystals.

The term “self-alignment” adopted here therefore identifies a material that has the ability to produce the desired long-range alignment without needing to be subjected to “rubbing”, but spontaneously produces, before or during the cross-linking step, internal reorganisation in such a way as to produce this long-range alignment.

It is further important to note that a “self-alignment” process spontaneously produced by a material has the advantage of being performed selectively and at the same time very reliable and reproducible, unlike other complex solutions in the state of the art.

The process for preparing a photomobile polymer 2 of the present invention comprises the following steps:
a) doping by incorporation into a liquid crystal polymer of ZnO nanoparticles in a concentration comprised between 3 and 9% of the total;
b) deposition of the doped polymer obtained at the end of step a) onto a suitable substrate provided that no rubbing process takes place in step b).

Preferably, in step a) the ZnO nanoparticles are in a concentration comprised between 3 and 7.5 wt % of the total, even more preferably in a concentration greater than and different from 6 wt % and less than or equal to 7.5 wt %.

After numerous targeted studies, the Applicant has found that when the concentration of ZnO nanoparticles is very specific and greater than or different from 6% and less than or equal to 7.5% surprising and advantageous synergistic process takes place between the liquid crystal portion and the ZnO nanoparticles, leading to a long range “self-alignment” of the liquid crystals.

In more detail, in fact, the Applicant found that inserting an amount of ZnO nanoparticles greater than 7.5% by weight begins to create aggregates between the nanoparticles themselves that are substantially depleted of the polymer matrix and become incapable of guaranteeing the homogeneity of the system and thus the uniformity of behaviour as photopolymers.

Furthermore, the Applicant has found that an inverse effect to that described above occurs when the concentration of ZnO is less than 6% by weight; in fact in this case, zones can be formed with no ZnO nanoparticles, thus creating islands of liquid crystals as such, which would need to be aligned (e.g. by rubbing) to preserve their photomobile properties.

A liquid crystal polymer may be any liquid crystal polymer characterised by the presence of liquid crystal monomers (LCM) and liquid crystal polymers (LCP) where “liquid crystal” means any mesophase-forming mesogenic compound, including lyotropic and thermotropic compounds. In general, it is appropriate to emphasise that monomer/polymer liquid crystals exhibit the properties of both monomers/polymers and liquid crystals.

According to an embodiment of the present invention, presented by way of non-limiting example, a liquid crystal photomobile polymer 2 is obtained by the polymerisation of a non-cross-linked resin 1 comprising at least one liquid crystal having one or more functional groups for the polymerisation, at least one azobenzene-based monomer, at least one monomer and/or at least one oligomer and/or at least one polymer or combinations thereof, in the presence of an initiator. Preferably, a glass or plastic substrate is used.

In other words, the photomobile polymer 2 according to the present invention is obtained by the process of doping a non-cross-linked resin 1 comprising at least one liquid crystal monomer and/or oligomer having an azobenzene moiety with ZnO nanoparticles in a concentration comprised between 3 and 9%.

The Applicant has noted that such ideal technical advantages are not achievable with any type of nematic liquid crystal, as it is necessary for applications as real and efficient final photopolymers to have a long-range nematic alignment in a directrix capable of responding with sufficient mechanical and physical characteristics. If this is not done, the resulting material will not be able to perform adequately and will therefore be deemed unsuitable.

The Applicant therefore identified the azobenzene moiety with ZnO nanoparticles in the specific claimed concentration as an ideal and synergistic combination of characteristics essential to achieve the desired photopolymeric behaviour and benefits.

Preferably, the process for the preparation of the photomobile polymer 2 comprises the deposition of said photomobile polymer 2 on a suitable substrate that has not previously undergone rubbing.

The photomobile polymer 2 according to the invention, consists of a resin comprising at least one liquid crystal monomer and/or oligomer comprising an azobenzene moiety in a concentration comprised between 6 and 10 mol %, and ZnO nanoparticles in a concentration greater than and different from 6% and less than or equal to 7.5%. Preferably, the azobenzene moiety is functionalised with at least one functional group adapted for polymerisation linked to aliphatic chains consisting of 3 to 11 carbons.

More preferably, at least one functional group is chosen from the group consisting of acrylates, methacrylates, epoxies and/or combinations thereof.

Preferably, the liquid crystal monomer and/or oligomer alone or in combination has a nematic temperature comprised between 20° C. and 50° C. Preferably, the liquid crystal monomers/oligomers/polymers have a flexural modulus comprised between 0.3 and 1.3 Gpa, or greater.

The magnitude of the flexural modulus is measured by dynamic mechanical analysis and represents the material's response to tensile stress with elastic deformation in the 1% range.

These flexural modulus values are functional to the printing process in that they allow the printed material that will be obtained from the resin to move efficiently and with ideal reversible response times once irradiated by specific radiation, e.g. light.

Preferably, the initiator can be a temperature-sensitive substance or a light-sensitive substance.

Preferably, the initiator is a photo-initiator sensitive to light comprised between 300 and 405 nm, or comprised between 405 and 680 nm.

By way of example, light-activated initiators can be chosen from the group consisting of: benzylcyclohexyl-benzoylperoxide (BAPO), acetylentriol benzoate (AB), α-Benzoyl-o-phenoxy-isopropylbenzene (BPO-F), tert-butylperoxy-2,4-dicarbonate (TBP-DC), A-phenoxy-2,4,6-trimethyl-1,3,5-triazine (TPT), Irgacure-651.

As a non-exhaustive example, temperature-activated initiators can be chosen from the group consisting of: azobisisobutyronitrile (AIBN), di-tert-butyl peroxide-dicarbonate (DTBP-DC), 2,2′-Azobis(2-methylethanol) (A ME), tert-butylperoxy-isobutyl peroxide (TBP-IBP), dicumyl peroxide (DCP).

According to an embodiment, the polymerisation process comprises the steps of:
a. mixing in the absence of organic solvents of the starting products, wherein the liquid crystals are present in a percentage comprised between 97% and 85% of the total mass of the azobenzene-based monomers/monomers/oligomers/polymer, the azobenzene-based monomer is present in a percentage between 6 and 10% of the total mass of the azobenzene-based monomers/monomers/oligomers/polymer, the monomers/oligomers/polymers not based on liquid crystals, are present in a percentage between 3 and 15% of the total mass of the azobenzene-based monomers/monomers/oligomers/polymer
b. Addition of the mixture obtained at the end of step a) of the initiator in a percentage comprised between 1% and 15% of the total of the mixture obtained at the end of step a) and polymerisation until the resin is obtained as the final product

Below, by way of non-limiting example, possible formulations are reported for the photomobile polymer 2 made according to the present invention.

### EXAMPLE 1-4 OF DIFFERENT PHOTOMOBILE POLYMER FORMULATIONS AND THEIR CHARACTERISATIONS

A preparation of different photomobile polymers (PMPs) doped with different percentages of zinc oxide (ZnO) nanoparticles is described: basic mixtures of liquid crystal polymers (53% mol MAPE, 6% mol A 9zA9, 18% mol AOCB, 22% mol AOBM, 1% mol Phenylbis) were made, to which the following were added by weight, respectively:
1.5% ZnO,
3% ZnO,
6% ZnO,
7.5% ZnO

thus obtaining four different mixtures of non-cross-linked resins.

Further, from these mixtures, photomobile polymers (PMP) were produced with and without rubbing, plus some undoped (for control and comparison) and doped with ZnO for a total of ten films.

Optical and thermal characterisation described in more detail below was carried out on these ten samples.

The ten different photomobile polymers (PMPs) prepared as described above were tested with two different lasers (at 405 and 457 nm wavelengths, respectively) and the maximum bending angle as a function of power density was derived.

The optical characterisation performed showed that as the percentage of ZnO increases, the film's ability to bend increases.

In particular, the presence of ZnO nanoparticles is necessary for good laser response in terms of bending.

Furthermore, in comparison with the control sample (undoped PMP), it can be seen that ZnO replaces rubbing, allowing the doped PMP film to bend much better than the control. It has been shown that photomobile PMP polymers doped with ZnO in a concentration greater than 6% and less than or equal to 7.5% by weight differ in that photomobile PMP polymers with a ZnO weight greater than 6% are able to reversibly return to the resting state when radiation is interrupted, whereas this behaviour does not appear to be highlighted by the further formulations.

Further thermal characterisations were carried out via differential scanning calorimetry (DSC) and thermogravimetry (TGA) to assess, respectively, the presence of an effect of the ZnO nanoparticles on the glass transition temperature (Tg) with respect to the undoped control photomobile polymer, and to confirm the weight percentages of ZnO actually present in the respective PMP photomobile polymers. Differential scanning calorimetry (DSC) analyses conducted show that the % of ZnO does not influence the glass transition temperature (Tg) of the photomobile polymer (PMP) as all the values are around 40° C.

Thermogravimetric analysis (TGA) shows that the percentage of ZnO does not influence the temperature at which 5% by weight is lost. There is a 6.55% residue in the control, due to carbon chains formed during the thermal process. For other ZnO concentrations, the residue is the sum of these carbon chains plus the percentage of ZnO put into the photomobile polymer (PMP). For example, for the photomobile polymer (PMP) with 1.5% by weight of ZnO, the residue is 7.99%, which compared to the control residue (6.55%) is approximately 1.5% more, and likewise for the other photomobile polymers (PMP) tested.

Further comparison analyses were carried out on similar rubbed and unrubbed preparations, in particular, a control i.e. photopolymer undoped with ZnO and samples of photopolymers doped with increasing percentages of ZnO were prepared: 1.5%, 3%, 6%, 7%, 7.5%.

They were tested with two different lasers (with wavelengths at 405 nm and 457 nm) and the maximum bending angle was derived as a function of power density.

The data showed that samples subjected to rubbing exhibit the mechanical directrix that liquid crystals follow according to the nematic temperature. This implies that samples without ZnO do not function beyond this value, but functionality is restored by the presence of ZnO, in a concentration comprised between 3 wt % and 7.5 wt %, wherein above 6 wt %, performance improves as a function of the wavelength of 457 nm.

It has been shown that when not rubbed, the samples do not exhibit the mechanical directrix that liquid crystals follow at the nematic temperature, however, the performance is better than the relative samples cross-linked on substrates treated with rubbing particularly at ZnO concentrations greater than 6 wt %.

The applicant has developed the method for 3D printing the photomobile polymer 2 with at least some of the previously described characteristics.

The invention is a new approach for 3D/4D printing (in which the time constant is added to 3D printing) of light-activated resins to produce objects that can move when interacting with a light stimulus. This effect can be achieved with the use of liquid crystals CL comprising photoswitchable moieties using an alternative approach to stereolithography SLA or resin 3D printing with digital light processing (DLP). As previously described, the invention concerns a new 3D printing process and/or 3D printer for quickly and efficiently obtaining three-and four-dimensional objects that can move when stimulated by light. The formulation of the resin as previously described is a significant factor, particularly for its use with different light sources, e.g. promoting alignment versus polymerisation and respecting alignment times versus polymerisation times.

Further, the addition of nanoparticles to the non-cross-linked resin of the photomobile polymer can facilitate the production process by avoiding alignments of certain regions/layers of the print.

In fact, by adopting the resin according to an aspect of the present invention, it is possible to implement the aforementioned “self-alignment”, which allows for a spontaneous long-range alignment phase without having to apply an interaction to the resin with a surface or medium that imposes a physical direction on the portion of liquid crystals.

It is immediately evident that the use of such a resin in the 3D (or 4D) printing process is significantly advantageous by combining the ease of implementation of such a printing process with the physical-mechanical properties of the resin for a desired photomobile polymer.

The 3D (or 4D) printer according to the present invention is configured to use the VAT polymerisation method, which preferably adopts UV light to polymerise liquid resins in a container (VAT).

As shown for example the VAT container is a tank 10 made of polymer and/or metal material.

The tank 10 comprises a handling device 11 configured to move a movable bed 12 inside said tank 10. Such a handling device 11 is a track on which a pure translation slide or similar kinematic mechanism runs.

The movable bed 12 is a horizontally oriented flat surface with a substantially square or rectangular cross-section.

In the embodiments, the printer comprises a first and a second light source.

In the embodiment shown, the first light source is a light that stimulates the self-alignment (perpendicular to the electric field of the light) of the liquid crystals within the VAT while the second light source is configured to polymerise and/or self-align specific fractions of the object to be printed.

In particular, the second light source SL2 is a polarised or unpolarised laser capable of both triggering polymerisation for the construction of a three-dimensional object and of modifying the local self-alignment of the liquid crystals in certain parts of the printed material in a detailed and precise manner. This is intended to give the liquid crystals a defined general arrangement according to the first light source and alternative alignments for the different movement dimensions of the PMP.

The first light source SL1 is configured to be movable at 180° with respect to a plane of the VAT tank 10.

Alternatively, the first light source SL1 is a programmable LED strip housed in contact with the wall of the tank 10.

For the sake of clarity, although the aforementioned photomobile polymer printing process is preferably rapid and continuous, it is described below as being divided into different steps.

In particular, two methodologically distinct steps can be recognised within this process: alignment and sculpture.

The alignment step in the tank 10 of the non-cross-linked resin 1 of the photomobile polymer 2 can in turn be characterised by two different events.

The first event is the alignment itself, in which the liquid crystals CL comprised in the non-cross-linked resin 1 self-align, due to the presence and contribution of the azobenzenes with ZnO nanoparticles in the claimed concentrations, perpendicular to the electric field of the light radiated by the light source SL1 on the non-cross-linked resin 1.

The second event is an alignment whereby, if the initiator in the formulation is activated by the light source SL1, standard polymerisation may occur. This type of event is designed and defined according to the application and alignment required for the photomobile polymer 2.

The light source SL1 can be switched off if necessary or used in pulsed mode to achieve more complex structures and optimise the time of use. This methodological approach is also compatible with other printing methods, such as inkjet or gravure printing.

It can be seen that the sculpture step is performed by activation of the second light source SL2.

In particular, this step allows for the detailed polymerisation and self-alignment of the liquid crystals CL of the non-cross-linked resin 1 of the photomobile polymer 2 in alternating patterns that facilitate the creation of a final polymeric article comprising the photomobile polymer 2 capable of moving, when exposed to specific radiative stresses, in multiple dimensions.

This second sculpture step features various second light sources SL2 depending on the application.

Two embodiments are described below, which are also non-limiting examples.

The first example is a simple configuration of the 3D printer 100 in which local or voxel alignment is not necessary.

In fact, in this case, the second light source SL2 is a simple lamp (not a laser) that polymerises the second cross-linking layer SR2, which essentially coincides with the first cross-linking layer SR1 that was mainly aligned by the first light source SL1.

In this case, different shapes for different layers require the use of Transmissive LCD displays.

In this case, the photomobile polymer 2 has a single alignment direction and no modelled fraction.

When specific and complex patterning is required, the lamp of the second light source SL2 is replaced with another type of radiative source.

It can be seen that in the case of specific patterning, the second light source SL2 is either a polarised laser or an unpolarised laser with a polarising foil capable of moving on the XYZ axis or a set of mirrors or photonic crystals capable of moving the laser light to all points on the printable surface.

In this case, the laser SL2 is configured to not only model the shape required for the photomobile polymer layer 2, but also to modulate different alignments in three dimensions, thus stimulating the formation of a complex mobility platform.

It can be seen that in the case where said second light source SL2 is a polarised laser, it is possible to irradiate the non-cross-linked resin 1 at an angle of incidence close to 0° so as to obtain an alignment parallel to the extension plane of the movable bed 12.

It is important to emphasise that the method 200 of 3D-printing a photomobile polymer 2 described here is advantageous over state-of-the-art techniques in at least two main respects.

The first is the use of collimated non-polarised light to align the azobenzenes comprised in the non-cross-linked resin 1, thus leading to an economic advantage over known solutions.

The second is determined by the possibility of using a second laser light source SL2 configured to locally polymerise the liquid crystals CL, producing a different local self-alignment from that produced in bulk at a more macroscopic level using the first light source SL1.

In order to emphasise the innovative effort made by the inventors, it is noted that by contrast in literature a complex and expensive technology including the adoption of a powerful magnet has been used, which could be a limited and non-exhaustive alternative to the proposed invention. Indeed, such a magnetic-based solution would not be suitable for creating alternating local alignments in the photomobile polymer 2. In fact, even if the magnet rotated rapidly around the tank, it would be very unlikely to have a precise three-dimensional alignment.

It seems appropriate to emphasise that an important portion of this invention is the non-cross-linked resin 1 which is used in the various aspects of the technology described above and claimed below.

In particular, liquid crystals CL are present in the non-cross-linked resin 2 used. Liquid crystal CL can be synthesised as an acrylate/epoxy/thiolenic monomer/polymer or other methodologies.

For application at least in 3D printing, there is also the need for such a non-cross-linked resin 2 to comprise a photosensitive group such as, for example, azobenzene. It is also interesting to consider that this 3D printer can polymerise said non-cross-linked resin 1 in the photomobile polymer 2 layer by layer, thus also offering the possibility of replacing or refilling the tank 10 containing an alternative resin with nanoparticles or other additives. In this way, different layers would give new dimensions to the print, opening up a wide range of applications.

1: A process for preparing a photomobile polymer (2) comprising the following steps:
(a) doping by incorporation into a liquid crystal polymer of ZnO nanoparticles in a concentration comprised between 3 and 9% of the total; and
(b) deposition of the doped polymer obtained at the end of step a) onto a suitable substrate provided that no rubbing process takes place in step b).

2: A photomobile polymer (2) obtained by a process comprising doping:
(a) a non-cross-linked resin (1) comprising at least one liquid crystal monomer;
(b) an oligomer having an azobenzene moiety in a concentration comprised between 6 and 10 mol %, with ZnO nanoparticles in a concentration greater than or different from 6% and less than or equal to 7.5% by weight, and
(c) a combination of (a) and (b),
wherein the deposition thereof is on an appropriate substrate in which the substrate is not previously subjected to rubbing.

3: A photomobile polymer (2) comprising a non-cross-linked resin (1), comprising at least one liquid crystal monomer and/or oligomer having an azobenzene moiety in a concentration comprised between 6 and 10 mol %, doped with ZnO nanoparticles, in a concentration greater than and different from 6% by weight and less than or equal to 7.5% by weight.

4: A method (200) of 3D printing a photomobile polymer (2) as set forth in claim 3, comprising:
(a) Arranging a tank (10) configured to contain a predetermined amount of a non-cross-linked resin (1) of said photomobile polymer (2), said tank (10) comprising a handling device (11) configured to move a movable bed (12) within said tank (10),
(b) Arranging a first light source (SL1), comprised in said tank (10), configured to selectively irradiate a first predetermined cross-linking layer (SR1) of said photomobile polymer (2) at said movable bed (12),
(c) Arranging a second light source (SL2), comprised in said tank (10), configured to selectively irradiate a second predetermined cross-linking layer (SR2) of said photomobile polymer (2) at said movable bed (12) producing cross-linking thereof,
(d) Inserting said non-cross-linked resin (1) into said tank (10),
(e) Positioning said movable bed (12) at the non-cross-linked resin (R) to be polymerised,
(f) Heating said tank (10) to a nematic temperature (Tn) of said non-cross-linked resin (1),
(g) Irradiating with said:
(i) first light source (SL1) and said first cross-linking layer (SR1) so as to achieve selective and localised self-alignment of said non-cross-linked resin (1),
(ii) second light source (SL2) and said second cross-linking layer (SR2) so as to sculpt said non-cross-linked resin (1) by polymerising and aligning it, or
(iii) both (i) and (ii), and
(h) printing of said photomobile polymer (2) by moving by means of said handling device (11) said movable bed (12) in order to irradiate with said first and/or second light source (SL1, SL2) a new cross-linking layer distinct from said first or second cross-linking layer (SR1, SR2) and repeating steps e to (g).

5: The 3D printing method of claim 4, wherein said first and second cross-linking layers (SR1, SR2) coincide.

6: The 3D printing method of claim 4, wherein said first light source (SL1) comprises:
(a) a collimated lamp;
(b) a strip of LEDs;
(c) a polarised source,
(d) polarised laser;
(e) an unpolarised laser associated with a polarising foil and a plurality of mirrors or photonic crystals configured to selectively and rapidly reflect said laser light at said first cross-linking layer (SR1), or
(f) any combination thereof.

7: The 3D printing method of claim 6, wherein the strip of LEDs is configured to irradiate said non-cross-linked (1) resin in a pulsed manner.

8: The 3D printing method of claim 6, wherein said polarised source is polarised perpendicular to said movable bed (12) and has a wavelength comprised between 350-365 nm.

9: The 3D printing method of claim 4, wherein said first light source (SL1) has a power density comprised between 0.8 and 2.8 W/cm².

10. : The 3D printing method of claim 4, wherein said first or second cross-linking layer (SR1, SR2) has a thickness comprised between 10 microns and 50 microns.

11: The 3D printing method of claim 4 wherein said movable bed (12) is coated with an alignment layer to facilitate an anchoring of liquid crystals comprised in said non-cross-linked resin (1).

12: A 3D printer (100) for printing a photomobile polymer (2) according to claim 2 by comprising
(a) a tank (10) configured to contain a predetermined amount of a non-cross-linked resin (1) of said photomobile polymer (2), said tank (10) comprising a handling device (11) configured to move a movable bed (12) within said tank (10),
(b) a first light source (SL1) configured to selectively irradiate a first predetermined cross-linking layer (SR1) of said photomobile polymer (2) at said movable bed (12) producing localised alignment thereof, and
(c) a second light source (SL2) configured to selectively irradiate a second predetermined cross-linking layer (SR2) of said photomobile polymer (2) at said movable bed (12) producing cross-linking thereof.
